(19) United States
(12) Patent Application Publication
(10) Pub. No.: US 2004/0107402 A1
(43) Pub. Date: Jun. 3, 2004

(54) Method for encoding and decoding a path in the tree structure of a structured document

(76) Inventors: Claude Seyrat, Paris (FR); Cedric Thienot, Paris (FR)

Correspondence Address: BACHMAN & LAPOINTE, P.C., 900 CHAPEL STREET, SUITE 1201, NEW HAVEN, CT, 06510, US

(21) Appl. No.: 10/470,250

(22) PCT Filed: Jan. 30, 2002
(86) PCT No.: PCT/FR02/00360

(30) Foreign Application Priority Data
Jan. 30, 2001 (FR) 01/01243

(51) Int. Cl. G06F 17/00

(52) U.S. Cl. 715/513

(57) ABSTRACT

The invention relates to a method for encoding and decoding a path that is applied to the hierarchical structure of a structured document, in which a path is defined by a series of segments that connect an originating node to a destination node. Each node represents a document information element which is associated with at least one type of information. The inventive method comprises: a preliminary stage whereby each node in the structure is assigned a list of pairs comprising a name and a type of information element, represented by all the nodes likely to be directly attached to the node, and whereby a respective binary code is allocated to each name/type pair, and a path encoding stage whereby the binary node code that represents the name/type pair of the destination node of the segment is determined (21, 22) for each segment of the path to be encoded, and (23) said code is subsequently inserted in the path code.

This invention relates to a method for encoding and decoding a path in a tree-like structure of a structured document.

It is particularly but not exclusively applicable to compression/decompression of parts of structured documents. For example, this type of document may consist of structured multimedia data, image data or sequences of video or digital image data, films or video programs, or data describing such information.

A structured document is a collection of information sets, each associated with a type and attributes, and related to each other by mainly hierarchical relations. These documents use a structuring language such as SGML, HTML or XML, which in particular distinguishes the different information subsets making up the document. On the contrary, in a so-called linear document, the information defining the document contents is mixed with presentation and typeset information.

A structured document includes separation markers for the different information sets in the document. In the case of SGML, XML or HTML formats, these markers are called “tags” and are in the form “<XXXX>” and “</XXXX>”, the first tag indicating the beginning of an information set “<XXXX>” and the second tag indicating the end of this set. An information set may be composed of several lower level information sets. Thus, a structured document has a hierarchical structure or tree-like structure schema, each node representing an information set and being connected to a node at a higher hierarchical level representing an information set that contains lower level information sets. Nodes located at the end of the branch of this tree-like structure represent information sets containing a predefined type of data that cannot be decomposed into information subsets.

Thus, a structured document contains separation tags represented in the form of text or binary data, these tags delimiting information sets or subsets that may themselves contain other information subsets delimited by tags.

Furthermore, a structured document is associated with what is called a structure schema defining the structure and type of information in each information set in the document, in the form of rules. A schema is composed of nested groups of information set structures, these groups possibly being ordered sequences, or ordered or unordered groups of choice elements or groups of necessary elements.

At the present time, when a structured document has to be transmitted, it is preferably firstly compressed so as to minimize the data volume to be transmitted, Document structuring data are also compressed to improve the efficiency of this type of compression processing, knowing that the document addressee is supposed to know the structure schema for the document beforehand and can use this schema to determine which information sets he will receive at any particular moment. Therefore, it is essential that the structure of the transmitted document should correspond precisely to the structure schema that the document addressee intends to use for reception and decoding of the document, otherwise in particular the addressee will not be able to determine the type of transmitted data, and will therefore be incapable of decoding them and reconstituting the original document.

The volume of structured documents to be transmitted is tending to become larger and larger. For example, the use of this means is being considered for the transmission or broadcasting of complete descriptions of films or television programs.

In this context, if a transmission error occurs during the transmission of a document, the document addressee will no longer be able to determine which subset is currently being transmitted, and in this case the entire document will have to be retransmitted Furthermore, if a cinematographic sequence is to be transmitted and displayed on a screen at the same time, it may be necessary to respect time slots for transmission of the different elements in the sequence Moreover, some elements in the sequence will also have to be transmitted several times to enable an addressee who was not connected at the beginning of the transmission of the sequence to receive and display the end of it.

It may also be necessary to replace part of a document by another, with the two parts having the same structure schema.

The solution consisting of retransmitting the entire document would considerably increase the volume of information to be transmitted. Therefore it is desirable to divide a document into several parts that can be used or transmitted separately. However, in order to be able to decompress part of the document, it is necessary to he able to determine exactly where this part of the document is located in the structure schema for the document.

Consequently, there are several solutions consisting of describing a path in the document tree structure, starting from the root node of the document and ending at the main node of the required part of the document. Methods of describing paths in a tree structure have been developed for this purpose. However, these methods are not optimized in terms of the number of information elements necessary to describe such a path. Furthermore, these methods are incapable of taking account of all available possibilities in the definition of a document structure schema, such that they do not always guarantee that the reconstituted path will be the same as the original path. Therefore, the result is the risk of errors in determining the position of a part of the document in the document tree structure, and therefore the risk of errors in decoding this part of the document, or decoding might even be impossible.

Thus, the XML-schema language now used in structured documents enables what is called polymorphism, in other words being able to define subtypes of a structured data type, the subtypes being special cases of data corresponding to the type. For example in a “character string” type, there may be a “month of the year” subtype. In this case, the structure model may indicate that a node in the tree structure is of the “character string” type and the document may include a “month of the year” type of information set at this node. This language also enables substitutions of information set names. But existing path encoding methods cannot handle these possibilities.

The purpose of this invention is to eliminate these disadvantages. This purpose is reached by providing a method for encoding a path in a structured document hierarchical structure, defined by a document structure schema, this path being defined by a sequence of segments, each segment connecting a source node and a destination node, each node representing an information element in the document, each information element being associated with at least one information type in the structure schema, characterized in that it comprises:

a preliminary phase, comprising a step of associating a list of pairs composed of a name and type of information element with each node considered in the structure schema, represented by all nodes that could be directly attached to the node considered, and to associate a binary code to each information element name and type pair, and

a path encoding phase comprising a step of determining a binary code for the node associated with the segment destination node name—type pair for each path segment to be encoded, and inserting it in the path code.

Advantageously, the path encoding phase also comprises a step of determining a binary position code for the segment destination node, to define the position with respect to other nodes that might be attached directly to the segment source node.

According to one special feature of the invention, the path encoding phase also comprises a step of generating a path code comprising a sequence of segment codes, each segment code comprising a node binary code for the segment destination node, and a binary position code for the segment destination node.

According to another special feature of the invention, the path encoding phase also comprises a step of generating a path code comprising a sequence of segment codes, each segment code comprising a node binary code for the segment destination node and a sequence of position codes giving the position of all nodes referenced in the sequence of segment codes.

Preferably, the preliminary phase also comprises a step of determining a maximum number of nodes that could be directly attached to the node considered, to determine the size of the node position binary code.

According to another special feature of the invention, at least one of the document structure information elements comprises attributes, the path to be encoded having an attribute as the destination element, the encoding phase also comprising a step to insert a segment type code in the code of each segment, indicating if the segment destination node is an attribute or an information element.

According to another special feature of the invention, the encoding phase also comprises a step to insert an end of path code in the path code.

Preferably, the end of path code is a segment type code with a predefined value.

According to yet another special feature of the invention, the source node of each segment is located at a higher hierarchical level than the destination node in the document structure schema, and the encoding phase also comprises a step to insert at least one segment type code with a predefined value into the path code, indicating that the next segment source node to be encoded is the previous segment destination node to be encoded.

According to another special feature of the invention, the encoding phase also comprises a step to insert a code in the path code, to indicate if the encoded path is an absolute path starting from the document root node, or a relative path starting from an arbitrary node in the document structure schema.

The purpose of the invention also relates to a method for decoding a path code in a hierarchical structured document structure, defined by a document structure schema, this path code comprising a sequence of segment codes, each segment connecting a source node to a destination node forming the source node of the next segment, each node representing an information element of the document, each information element being associated in the structure schema with at least one information type, characterized in that each segment is defined in the path code by at least one node binary code representing a name—type pair, composed of an information element name and type, for the information element represented by the segment destination node, the method comprising:

a preliminary phase of associating a list of information element name—type pairs with each node considered in the structure schema, each pair consisting of a name and a type of information element, represented by all nodes that could be attached directly to the node considered, and to associate a binary code corresponding to each information element name—type pair, and

a path code decoding phase of decoding the node code representing the name—type pair of the segment code destination node, using the list of destination node name—type pairs, for each path code segment to be decoded.

Advantageously, each segment also comprises a position code of the destination node with respect to other nodes that could be connected directly to the segment source node, within the path code to be decoded, and the decoding phase also comprises a step for each segment of decoding the binary position code of the segment destination node, as a function of the corresponding positions of all nodes that could be attached directly to the segment source node.

According to one special feature of the invention, decoding of the binary code for the node representing the information element name—type pair comprises a step to determine the size of this code as a number of bits and to search for the code in the list of name—type pairs for the segment source node.

According to another special feature of the invention, decoding of the binary position code of the segment destination node comprises determination of the size as a number of bits of this code as a function of the maximum number of nodes that could be attached directly to the segment source node.

Preferably, each segment code comprises a segment type code, the path decoding phase also comprising decoding of the segment type code for each segment.

Advantageously the segment type code for each segment code in the path code is used to determine if the destination node of the segment is an information element or an attribute of the segment source node.

According to another special feature of the invention, the method comprise s determination of the end of path code, which is marked by a segment type code with a first predefined value.

Preferably, if the segment type code has a second predefined value, the next segment code to be decoded in the path code has the same destination node as the previous segment source node to be decoded.

A preferred embodiment of the invention will now be described, as a non-limitative example with reference to the appended drawings, wherein:

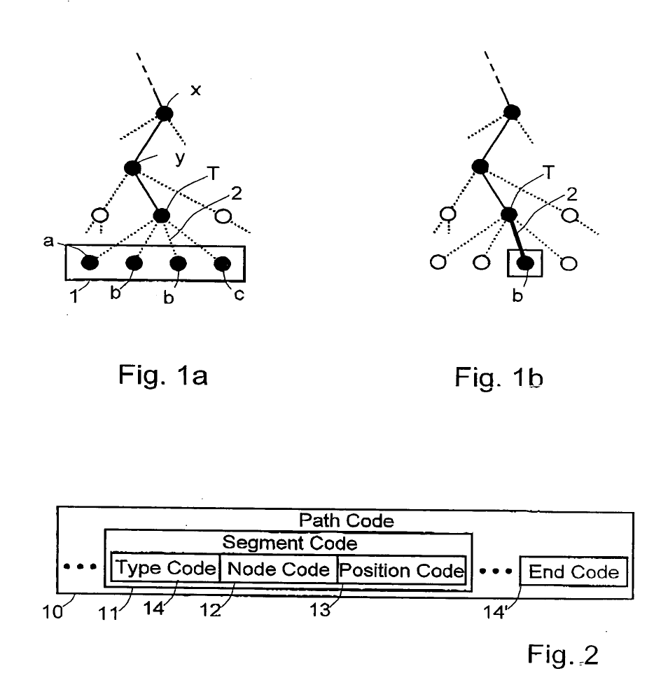

FIGS 1a and 1b represent a part of a tree structure of the structured documents in which each node represents an information set or subset, before and after the definition of a branch between the two nodes respectively;

FIG. 2 shows the general structure of a path according to the invention in a document tree structure;

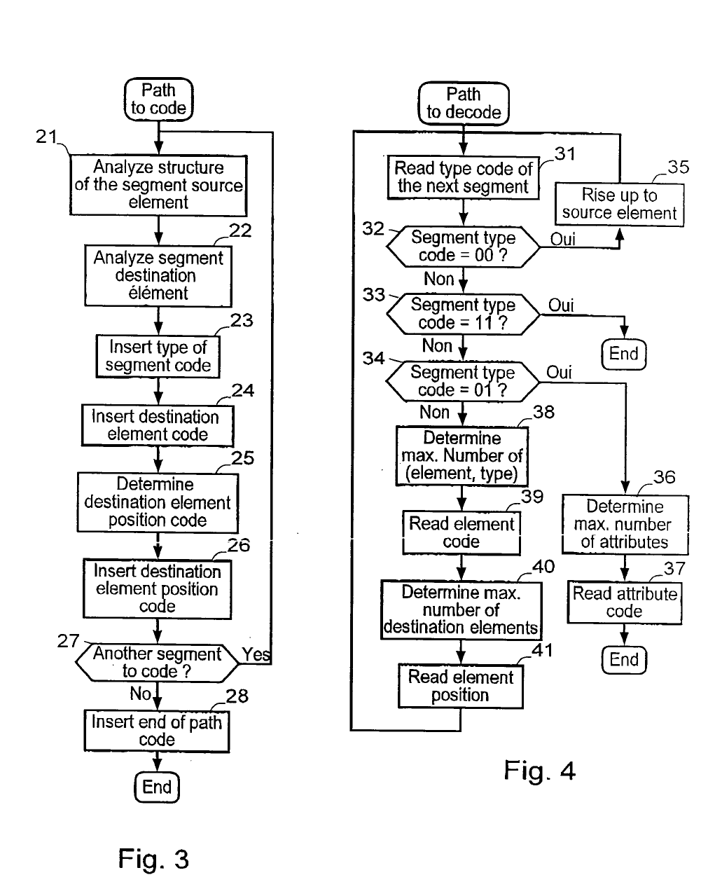

FIG. 3 shows the processing executed by a path encoding computer according to the invention, in the form of a flowchart;

FIG. 4 shows the processing executed by a decoding computer according to the invention, in the form of a

FIG. 1a shows a structure schema for a structured document comprising a node x that is not necessarily the root node of the document. This node x is composed of three nodes, but only the second of these nodes is shown in the figure. Node y is then broken down into three nodes, the second node being T, and node T itself comprises four nodes a, b, b and c shown in FIG. 1 as being inside the box 1.

The information set corresponding to node T is defined by the following structure schema:

<complexType name=“T”>
<choice minOccurs=“2” maxOccurs=“4”>
<element ref=“a” minOccurs=“0” maxOccurs=“1”/>
<element ref=“b” minOccurs=“1” maxOccurs=“1”/>
<element name=“c” type=“tc”/>
</choice>
<complexType>

This means that the complex type T comprises two or three occurrences of a group of choice elements (“choice” type), comprising not more than one element a, one element b and one element c of type tc. This structure may also be represented more compactly as follows:

CHOICE[2, 4](a[0, 1], b[1, 1], c[1, 1])

The fields introducing elements a and b refer to a definition of these elements of the following type, given later in the document structure schema:

<element name=“a” type=“ta”/>
<element name=“b” type=“tb”/>

The structure schema then comprises the definition of types ta, tb and tc that are defined similarly to the T type. It may also include element substitution instructions as follows:

<element name=“a1” type=“ta1” substitution Group=“a”/>

This instruction indicates that element al of type ta1 may be substituted for an element a. In this case, type ta1 forms a sub-type of ta. Similarly, type tb may comprise a subtype td. These subtypes are defined in structure schema as follows, using the “restriction” tag or “extension” tag provided for this purpose:

<complexType name=“ta1”>

<restriction base=“ta”>
. . .
</restriction>

<complexType>
<complexType name=“td”>

<restriction base=“tb”>
. . .
</restriction>

<complexType>

According to the XML-Xpath standard, the second node b connected to node T is marked as follows:

. . . /T/b[1]

This notation references the first node b connected to node T.

It is found that this notation is not optimum from the point of view of the size of the binary word necessary to represent it, and it does not take account of all specific features authorized by the XML-schema language such as polymorphism (possibility of defining sub-types of an information element type) or the possibility of replacing an element of one type by another element of the same type or a subtype of the same type.

With the method according to the invention, the first step is to analyze the complex type T structure schema of the source node of segment 2 connecting node T to node b, that we want to reference. The purpose of this analysis is to build up a table containing a list of all elements that could belong to the complex type structure T and all possible types of these elements. For the T type, the following table is obtained:

TABLE 1

| Element | Possible types | Substitution elements |
|---|---|---|
| a | tₐ, tₐₗ | a1 |
| a1 | tₐ₁ | None |
| b | t_{b}, t_{d} | None |
| c | t₀ | None |

This table indicates that element al can be substituted for element a, according to the definition of the schema in XML.

Starting from this table, the list of all (element, type) pairs of the complex type T is determined, these pairs being stored in a predetermined order, for example by alphabetic order of information element names and information element type names. A binary code is then associated with each pair, for example obtained by numbering them sequentially in the order in which they are stored, to give the following table:

TABLE 2

| Code | Pair (element, type) |
|---|---|
| 000 | (a, tₐ) |
| 001 | (a, tₐₗ) |
| 010 | (a1, tₐ₁) |
| 011 | (b, t_{b}) |
| 100 | (b, t_{d}) |
| 101 | (c, t_{c}) |
| 110 | Reserved |
| 111 | Reserved |

In general, a code on k bits is necessary to number objects, if the number of objects is between 2^{k-1}+1 and 2^{k}. Conversely, if N is the number of pairs, these pairs may be encoded on E(log₂(N)) bits (where E(x) is the “integer part” function). Codes not used for numbering may be reserved to carry out verification operations while decoding the path. Finally the objective is to define the number M of possible elements contained in the segment source node. In general, a distinction has to be made according to whether we need to process a “sequence” type elements group (ordered elements group), or a “choice” type elements group (choice elements group), or an “all” type elements group (necessary elements, ordered or not), or a simple element, each element obviously possibly representing a group of elements with a lower hierarchical level or a simple element.

A “sequence” type group of elements e1, e2, . . . , en (ordered elements list) may be represented as follows:

SEQ[min_{seq},max_{seq}](e1[minₑ₁,maxₑ₁], e2[minₑ₂,maxₑ₂], . . . , en[minₑₙ,maxₑₙ])

in which “minᵢ” and “maxᵢ” represent the minimum and maximum occurrence numbers of element ei.

If one of the maximum occurrence numbers maxᵢ is undefined or unbounded, then the maximum number M of possible positions of such a group is not bounded. Otherwise, it is obtained using the following formula:

$$M = {max}_{seq} \cdot {\sum }_{k = 1}^{n} {max}_{ek} \qquad ( 1 )$$

The minimum number m of occurrences may be obtained using the following formula:

$$m = {min}_{seq} \cdot {\sum }_{k ≃ 1}^{n} {min}_{ek} \qquad ( 2 )$$

A CHOICE type elements group (choice elements group) may be represented as follows:

CHOICE[min_{ch},max_{ch}](e1[minₑ₁,maxₑ₁], e2[minₑ₂,maxₑ₂], . . . , en[minₑₙ,maxₑₙ])

If one of the maximum numbers of occurrences maxᵢ is undefined or unbounded, then the maximum number M of possible positions of such a group is not bounded. Otherwise, it is obtained using the following formula:

$$M = {max}_{ch} \cdot {{max}_{k = j}}^{n} ( {max}_{ek} ) \\ {M}_{j} = ( {max}_{ch} - 1 ) \cdot {max}_{k = 1} ( {max}_{ek} ) + {max}_{ej} \qquad ( 3 )$$

where max( ) is a function giving the maximum value of all values in parameters

The minimum number of occurrences m of a “choice” type group is given by the following formula:

$$m = {min}_{ch} \cdot {{min}_{k = 1}}^{n} ( {min}_{ek} ) \qquad ( 4 )$$

where min( ) is a function giving the minimum value of all values in parameters.

An “all” type elements group (list of unordered elements) may be represented as follows:

ALL[minₐₗₗ,maxₐₗₗ](e1[minₑ₁,maxₑ₁], e2[minₑ₂,maxₑ₂], . . . , en[minₑₙ,maxₑₙ])

The maximum number of occurrences M and the minimum number m of such a group are obtained using the same formulas (1) and (2) as for a SEQ type group.

In the case of a simple element ek, the maximum number of occurrences M and the minimum number m of the element are given directly by the document structure schema.

If the maximum number of elements M thus obtained is bounded or is less than a given limit, for example 2¹⁶, then encoding of the position of an element requires E(log₂(M)) bits.

Otherwise, an encoding system must be adopted capable of encoding any integer number. Thus, for example, such a number can be encoded by groups of a predefined number of bits, for example 5 bits, the first bit of a group indicating whether or not the next four bits are the last encoding bits of the number

In the previous example shown in FIG. 1b, it is required to reference segment 2 connecting element T to the third element (marked by box 3) of node T, named b and of type td. With reference to Table 2, and considering the maximum possible number of positions on the downstream side of node T and the position of node b (third node) among these possible positions, segment 2 is numbered:

“100 10”.

The number of bits required to code six elements (see table 2) is three. Furthermore, the maximum number of possible positions on the downstream side of element T (in box 1) is 4, which requires encoding on two bits.

In the case of an SEQ type group, this encoding may advantageously be optimized using two methods, knowing that when all elements in a sequence are not optional, their position in the group is defined in a fixed manner.

According to the first method, limits are calculated between which the position of each element eᵢ in the sequence can vary, to reduce the number of bits necessary to code the position of the element.

These position limits Pₘᵢₙ and Pₘₐₓ for an element eᵢ (1≦i≦n, where n is the number of elements in the sequence) may be obtained using the following formulas:

$$\begin{matrix}{P}_{{min}_{i}} = 1 + {\sum }_{k = 1}^{j = 1} {min}_{ek} & ( 5 ) \\ {P}_{{max}_{i}} = 1 + {\sum }_{k = 1}^{i} {max}_{ek} + ( {max}_{seq} - 1 ) {\sum }_{k = 1}^{n} {max}_{ek} & ( 6 )\end{matrix}$$

According to the second method, the values of the possible positions of each element eᵢ in the sequence is calculated for each occurrence j in the sequence (min_{seq}≦j≦max_{seq}), using the following formulas:

$$\begin{matrix}{P}_{{min}_{i , j}} = 1 + {\sum }_{k = 1}^{i - 1} {min}_{ek} + ( j - 1 ) {\sum }_{k = 1}^{n} {min}_{ek} & ( 7 ) \\ {P}_{{max}_{i , j}} = {\sum }_{k = 1}^{i} {min}_{ek} + ( j - 1 ) {\sum }_{k = 1}^{n} {max}_{ek} & ( 8 )\end{matrix}$$

The following table was made for the group SEQ[1, 3](a[1, 1], b[1, 1]). This table gives the possible position numbers for each encoding method and for each element in the group, with the number of bits necessary for encoding the position of the element.

TABLE 3

| | without | | | | | |
|---|---|---|---|---|---|---|
| element | optimization | | method 1 | | method 2 | |
| a | 1 . . . 6 | 3 bits | 1 . . . 5 | 3 bits | 1, 3, 5 | 2 bits |
| b | 1 . . . 6 | 3 bits | 2 . . . 6 | 3 bits | 2, 4, 6 | 2 bits |

This table shows that the second optimization method can save one bit on the position code of an element in a sequence group.

Furthermore, in the case in which the position of “son” nodes attached to a “father” node in a structure is defined such that only one possibility is authorized, the methods mentioned above for optimizing the position encoding completely eliminate the need for this position code in the corresponding segment code. For example, this is the case for a sequence of elements in which all elements appear only once:

SEQ[1, 1](e1[1, 1], e2[1, 1], . . . , en[1, 1])

In the case of a CHOICE type group, this encoding may also be optimized calculating the maximum limit of the position of each element eᵢ in the group. This maximum limit Pₘₐₓ for an element eᵢ (1≦i≦n, where n is the number of elements in the group) may be obtained using the following formula:

$${P}_{{max}_{i}} = ( {max}_{ch} - 1 ) \cdot {{max}_{k = j}}^{n} ( {max}_{ek} ) + {max}_{cj} \qquad ( 9 )$$

In FIG. 2, the definition of a path segment in a structure schema tree comprises a field containing a node code 12, in other words an (element, type) pair number and a position code 13 of the segment destination node, relative to other nodes attached to the segment source node T, in other words the other elements contained in the element.

Note that a node position is encoded independently of the node type. This is unlike the XML standard in which this position is identified with respect to the node type. In the example “. . . /T/b[1], b is the first node b of node T, but is not necessarily the first element of node T.

Therefore, a path 10 in a structure schema tree structure is defined by a sequence of segments 11, each segment comprising at least one node code 12 and possibly a position code 13.

In this respect, it may sometimes be advantageous to withdraw segment codes 11, position codes 13 from all nodes referenced in a path code 10, and placed separately in an area provided for this purpose in the path code.

A delimiter code 14′ marking the end of the sequence of segments defining a path in the document structure, and therefore the beginning of encoded information about the document element referenced by the path, then needs to be inserted.

Furthermore, the XML language is a means of associating attributes to the different information elements of a document. In this context, if it is also required to allow the definition of a path towards an attribute of an element, each segment code 11 will be associated with a segment type code 14 (FIG. 2) to be able to determine whether the segment destination object is another element called a “son” element of the segment source node, or an attribute of the source node.

As before, the code of a segment 11 between an information element and an attribute of this element comprises an attribute code obtained by numbering all possible attributes of the element. On the other hand, since the attributes of an element are not ordered, there is no need to provide a position field in the segment code between an element and an attribute.

Advantageously, the segment codes to an element or to an element attribute are defined in the following table:

TABLE 4

| Code | Meaning |
|---|---|
| 00 | go towards the father |
| 01 | go towards the attributes table |
| 10 | go towards the elements table |
| 11 | End of path indicator |

In the above example (FIGS. 1a, 1b), the segment between element T and the third element b is fully defined by the following code:

“10 100 10”

Therefore, according to the invention as illustrated in FIG. 2, a path in a tree structure is composed of a sequence of segment codes 11 like those defined above, terminated by an end of path type code 14′, namely “11” according to Table 4.

Moreover in Table 4, the code “00” is a means of defining the position of an element in a structured document relative to a previously treated element. Thus, it provides a means of inputting a segment code of another element connected to the source node of the previous element or an attribute of this node. This code may also be followed by other identical codes to rise through several nodes within the tree structure of the document structure schema.

FIG. 3 shows a flowchart illustrating the processing done by a computer programmed to code the path according to the invention.

In this figure, the encoding processing comprises a preliminary step to analyze the document structure to determine the contents of Table 2, the list of element attributes and the maximum number of “son” elements included in the element, for each of the structure information elements.

Starting from the path to be encoded that can be represented in the form of an XML path as mentioned above, the encoding computer according to the invention executes step 21 that consists of reading the name of the source element of the first segment of the path to be encoded. In step 22, the encoding computer determines if the destination object of the current segment is an attribute or an information element. In step 23, the encoding computer inserts the segment type code 14 into the path code 10 to be determined, and this segment type code will be equal to “01” or “10”, depending on whether the destination object of the current segment is an attribute or an element. The encoding computer then executes step 24 to insert the attribute code or the pair code (element, type) 12 read in Table 2 corresponding to the source element of the segment currently being encoded.

If the destination object of the current segment is an attribute, the encoding processing is terminated.

If the destination object is an information element, the encoding computer determines the position of the destination element of the current segment starting from the path to be encoded, and determines the binary code of this position as a function of the maximum number of elements connected to the source element of the segment. In step 26, it inserts the position code 13 thus determined into the path code, after the pair code 12 (element, type).

If the path to be encoded in step 27 contains another segment, the encoding computer executes steps 21 to 27 on the next segment, in other words assuming that the source node of the segment to be encoded is the destination node of the previously encoded segment. Otherwise, it inserts the code 14′ for segment type “11” to mark the end of the path code (step 28).

As mentioned above, the path to be encoded may be defined in relative terms, with respect to a destination information element of a previously encoded path. In this case, the new path to be encoded in relative mode includes firstly one or several segment type codes equal to “00”, the number of these codes indicating the number of levels in the hierarchical structure of the structure schema through which it is necessary to rise to reach the node to be referenced by the new path to be encoded.

FIG. 4 shows a flowchart illustrating the processing done by a computer programmed to decode paths according to the intention.

This type of computer also carries out a prior analysis of the document structure schema to obtain Table 2, an attributes table and the maximum number of “son” elements included in the element, for each information element in the structure.

In step 31, the decoding computer reads the first two bits of the encoded path 10, giving a segment type code 14 as defined in Table 4.

If the segment code is equal to “10”, indicating that the next object in the path is an information element (steps 32 to 34), the decoding computer reads Table 2 corresponding to the first element, in step 38, to determine the number of bits used to code element pairs (element, type). In the case of an absolute path, the first element is the root element of the document structure.

In step 39, it reads the code 12 of the first element on the number of bits thus determined, in the path code, and uses the code read and Table 2 corresponding to the first element, to determine the name and type of the element corresponding to the destination element of the first segment. It uses the maximum number of “son” elements contained in the first element to determine the number of bits to be read afterwards in the path code 10 to be decoded (step 40) and reads (step 41) the position code 13 of the element in the path code, on the number of bits thus determined. The decoding computer then executes steps 31 to 41 for the next segment code 11 in the path code 10 to be decoded, the destination node of the previously decoded segment becoming the source node for the new segment to be decoded.

If the segment type code 14 read in the path code to be decoded in steps 32 to 34 is equal to “01”, the destination object of the segment being decoded is an attribute of the current element. In this case, the decoding computer reads the attributes table for the current element to determine the number of bits on which the attribute number is encoded in the path code (step 36), and reads the number of bits thus determined in the path code to obtain the attribute number (step 37), which is used to determine the destination attribute of the current segment using the attributes table of the current element. The path decoding processing is then terminated.

If the segment code 14 read in the path code to be decoded during steps 32 to 34 is equal to “11”, decoding of the path code is also terminated. If the segment code is equal to “00”, this means that the path to be decoded has been encoded in relative mode and that it is necessary to rise up to the segment source information element that has just been decoded (step 35). If this code appears again, the decoding computer rises another level in the tree structure to position itself at the node above the current node.

In other words, every time that the code “00” appears, the destination information element for the next segment to be decoded is the source node for the previous segment to be decoded.

The end of path code 14′ of the path code 10 marks the beginning of encoded information contained in the destination information element for the last segment thus decoded.

It would also be possible to consider a particular code placed at the beginning of a path code 10 to indicate if the path that follows is encoded in relative mode or in absolute mode. If in absolute mode, the information element of the first segment is the root node of the tree structure of the document. If the path is encoded in relative mode, the decoding computer is positioned on the “father” element of the current element.

1. Method for encoding a path in a structured document hierarchical structure defined by a document structure schema, this path being defined by a sequence of segments, each segment connecting a source node and a destination node, each node representing an information element in the document, each information element being associated with at least one information type in the structure schema,
characterized in that it comprises:
a preliminary phase comprising a step of associating a list of pairs composed of a name and type of information element with each node considered in the structure schema, represented by all nodes that could be directly attached to the node considered, and to associate a binary code with each information element name and type pair, and
a path encoding phase comprising a step of determining a binary code for the node (12) associated with the segment destination node name—type pair, for each path segment to be encoded, and inserting it in the path code.

2. Encoding method according to claim 1, characterized in that the path encoding phase also comprises a step of determining a binary position code (13) for the segment destination node, to define the position with respect to other nodes that might be attached directly to the segment source node.

3. Encoding method according to claim 1 or 2, characterized in that the path encoding phase also comprises a step of generating a path code (10) comprising a sequence of segment codes (11), each segment code comprising a node binary code (12) for the segment destination node, and a binary position code (13) for the segment destination node.

4. Encoding method according to claim 1 or 2, characterized in that the path encoding phase also comprises a step of generating a path code (10), comprising a sequence of segment codes (11), each segment code comprising a node binary code (12) for the segment destination node and a sequence of position codes (13) giving the position of all nodes referenced in the sequence of segment codes.

5. Encoding method according to one of claims 1 to 4, characterized in that the preliminary phase also comprises a step of determining a maximum number of nodes that could be directly attached to the node considered, to determine the size of the node position binary code (13).

6. Encoding method according to one of claims 1 to 5, characterized in that at least one of the document structure information elements comprises attributes, the path to be encoded having an attribute as the destination element, the encoding phase further comprising a step of inserting a segment type code (14) in the code (11) of each segment, indicating if the segment destination node is an attribute or an information element.

7. Encoding method according to one of claims 1 to 6, characterized in that the encoding phase further comprises a step of inserting an end of path code (14′) in the path code (10).

8. Encoding method according to claim 7, characterized in that the end of path code (14′) is a segment type code (14) with a predefined value.

9. Encoding method according to one of claims 6 to 8, characterized in that the source node of each segment is located at a higher hierarchical level than the destination node in the document structure schema, and the encoding phase further comprises a step of inserting at least one segment type code (14) with a predefined value into the path code, indicating that the next segment source node to be encoded is the previous segment destination node to be encoded.

10. Encoding method according to one of claims 1 to 9, characterized in that the encoding phase further comprises a step of inserting a code in the path code (10), to indicate if the encoded path is an absolute path starting from the document root node, or a relative path starting from an arbitrary node in the document structure schema.

11. Method for decoding a path code (10) in a hierarchical structured document structure, defined by a document structure schema, this path code comprising a sequence of segment codes (11), each segment connecting a source node to a destination node forming the source node of the next segment, each node representing an information element of the document, each information element being associated in the structure schema with at least one information type,
characterized in that each segment is defined in the path code (10) by at least one node binary code (12) representing a name—type pair, composed of an information element name and type, for the information element represented by the segment destination node, the method comprising:
a preliminary phase of associating a list of information element name—type pairs with each node considered in the structure schema, each pair consisting of a name and a type of information element, represented by all nodes that could be attached directly to the node considered, and to associate a binary code corresponding to each information element name—type pair, and
a path code decoding phase of decoding the node code (12) representing the name—type pair of the segment code destination node, using the list of destination node name—type pairs, for each path code (10) segment to be decoded.

12. Decoding method according to claim 11, characterized in that each segment further comprises a position code (13) of the destination node with respect to other nodes that could be connected directly to the segment source node, within the path code (10) to be decoded, the decoding phase also comprising a step of decoding, for each segment, the binary position code (13) of the segment destination node, as a function of the corresponding positions of all nodes that could be attached directly to the segment source node.

13. Decoding method according to claim 11 or 12, characterized in that decoding of the binary code for the node (12) representing the information element name—type pair comprises a step of determining the size of this code as a number of bits and to search for this code in the list of name—type pairs for the segment source node

14. Decoding method according to one of claims 11 to 13, characterized in that decoding of the binary position code (13) of the segment destination node comprises a step of determining the size of this code as a number of bits, as a function of the maximum number of nodes that could be attached directly to the segment source node.

15. Decoding method according to one of claims 11 to 14, characterized in that each segment code (11) comprises a segment type code (14), the path-decoding phase also comprising decoding of the segment type code for each segment.

16. Decoding method according to claim 15, characterized in that the segment type code (14) for each segment code (11) in the path code (10) is used to determine if the destination node of the segment is an information element or an attribute of the segment source node.

17. Decoding method according to claim 15 or 16, characterized in that it comprises a step of determining the end of path code, which is marked by a segment type code (14′) with a first predefined value.

18. Decoding method according to claim 15 or 17, characterized in that if the segment type code (14) has a second predefined value, the next segment code (11) to be decoded in the path code (10) has the same destination node as the previous segment source node to be decoded.
